(19) United States
(12) Patent Application Publication
(10) Pub. No.: US 2008/0133063 A1
(43) Pub. Date: Jun. 5, 2008

(54) WATER LEAK DETECTION SYSTEM

(76) Inventors: Eric BISSON, Quebec (CA); Pierre CHAPUT, Beauport (CA)

Correspondence Address: GOUDREAU GAGE DUBUC, 2000 MCGILL COLLEGE, SUITE 2200, MONTREAL, QC, H3A 3H3, omitted

(21) Appl. No.: 11/950,895

(22) Filed: Dec. 5, 2007

(30) Foreign Application Priority Data
Dec. 5, 2006 (CA) 2,569,944

(51) Int. Cl. G08B 21/00; G05D 7/06; G01P 21/00

(52) U.S. Cl. 700/282; 340/605; 73/1.16

(57) ABSTRACT

A water leak detection system for generating a control signal indicative of a water leak detection. The system is connectable to a power line carrying an AC power signal. The system includes a master unit connectable to the power line for generating the control signal indicative of a water leak detection. One or more slave units are connectable to the power line for communicating with the master unit. One or more sensors are connected to the slave unit for detecting a water leak. A communication system transmits and receives data signals between the master unit and each slave unit in the AC power signal. The communication system includes an encoder for encoding outbound data into the AC power signal using frequency shift keying (FSK) signals and a decoder for decoding inbound frequency shift keying (FSK) signals from the AC power signal.

### FIELD OF THE INVENTION

The present invention relates to water leak detection systems for residential and commercial applications. More specifically, the present invention relates to a water leak detection system powered using available voltage from the site were the system is installed and using a power line communication (PLC) technology.

### BACKGROUND OF THE INVENTION

Many types of water leak detection systems are known in the art. In response to a water leak detection, some systems only send an alarm signal while others command an action to stop the leak. An action can also be taken to prevent a leak in response to diverse conditions such as a temperature drop, a change in pressure or a power shut down. The components of the existing systems communicate through cables, wireless signals or through existing power lines. Water leak detection systems frequently comprise many components separated by floors and concrete walls. The installation of cables can be long and costly and the reliability of the communication through wireless signals can be compromised by the many obstacles and great distances between components. Therefore, using the existing power lines to transmit data signals is a solution that offers a simple installation and allows communication over great distances or through a considerable obstacle.

However, the main problem when using power lines to send communication signals between the water leak detection system components is the noise generated by other devices already connected or added to the same power line after the installation of the detection system.

### SUMMARY OF THE INVENTION

According to the present invention, there is provided a water leak detection system for generating a control signal indicative of a water leak detection, the system being connectable to a power line carrying an AC power signal, the system comprising: a master unit connectable to the power line for generating the control signal indicative of a water leak detection; one or more slave units connectable to the power line for communicating with the master unit; one or more sensors for detecting a water leak, each sensor being connected to a slave unit; and a communication system for transmitting and receiving data signals between the master unit and each slave unit in the AC power signal, the communication system including an encoder for encoding outbound data into the AC power signal using frequency shift keying (FSK) signals and a decoder for decoding inbound frequency shift keying (FSK) signals from the AC power signal.

Preferably, the system is includes water sensors linked to slave units, a master unit linked to a water valve, and a system display unit also being a slave unit. All units can intercommunicate through the existing power lines. Preferably, the system shuts a water valve installed at a chosen location in the facility upon a water leak detection, or shuts a water valve directly located at an equipment using pressurized water.

The master unit is adapted to recognize all slaves and monitor them on a regular basis. The master unit receives water detection signals from any water sensing slave unit. Upon reception, the master shuts the water valve OFF, switches the proper LED of the display unit and runs the alarm routine if this feature is programmed. Upon detection of a bad communication, the master unit switches the proper LED of the display unit. The master unit may be equipped with a temperature sensor to shut the valve when the ambient temperature reaches the 35 F limit for example. The master unit may also have an input for a water detection sensor. Upon water sensing, the master unit shuts the valve off and switches the proper LED of the display unit. The master unit may be programmed to shut the water valve if the main power is shut down for any reason.

Upon installation of all slaves units, within seconds the master unit sends a discovery program to find the matching slave units. The master unit may create up to three (3) different routing maps in case of actions such as electrical system modifications, facility renovations, or slaves addition. In fact, the master unit as well as the slave un units may repeat the signal intended to another, thereby regenerating the signal to its full initial strength. Therefore, a signal from the master unit can reach a slave unit directly or via another slave. The master unit may monitor the slaves unit every minute and chooses the route having the fastest communication speed. This rerouting provides for an increased efficiency of the system. The system can be compared to the Internet: by increasing the number of slaves, the efficiency of the system is increased.

The system is stand alone, operates without a computer and can be linked to an existing alarm system, or send a signal over the Internet or over a phone line to a regular phone, a cellular, a central monitoring data center or any other reception means.

The system's focus is not high speed but reliability of communications over long distances where data rates required fall below 50 Kbps and often as low as 60 bps. Preferably, the system complies with the various international conducted emission regulations related to PLC: FCC (usa) CENELEC (Europe and Asia) and IECS-006 (Canada).

Advantageously, the master-slave topology requires none or a minimal wiring installation since every unit can be connected to any duplex plug located throughout the facility where the water leak detection system is installed. There is no need to add new communication cables between components, often quite distant and separated with walls and concrete floors. Therefore the water leak detection system main advantage is to significantly reduce installation time and cost in an existing environment.

The use of frequency shift keying (FSK) signals to encode the data into the power signal and is far superior to any other Control Networking PLC technology against the noise generated from components such as halogen lights, laptop computer switching supplies, electric motor driven appliances or tools and all the above put together.

Preferably, the present system does not need for voltage couplers, phase couplers or noise filters, which makes the system more reliable, less complicated and secure from any future accessory addition within the facility.

Preferably, the present system is secure using the NSA Skipjack™ encryption algorithm which has an 80 bit-encryption key and a security level describe as follows: General communication; Network management; Installer-specific data; and Manufacturer-specific data.

Preferably, the present system uses a communication system which focuses on reliability rather than speed of data communications over long distances. This is possible since data rates required for the water leak detection system fall below 50 Kbps and often as low as 60 bps.

Advantageously, the present system is intended to reduce insurance claims and other inconveniences for owners of residential or commercial facility where water damages may happen.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is a schematic representation of a water leak detection system's master unit and valve connections, according to a preferred embodiment of the invention.

FIGS. 2A, 2B and 2C are respectively an isometric perspective view of a slave unit, an elevated top view and an elevated side view of a water sensor of a water leak detection system, according to a preferred embodiment of the invention.

FIGS. 3A and 3B are respectively a front view and a side view of a display unit of a water leak detection system, according to a preferred embodiment of the invention.

FIG. 4 is a schematic representation of a water leak detection system's ethernet modem connections, according to a preferred embodiment of the invention.

FIG. 5 is a schematic representation of a water leak detection system's phone modem connections, according to a preferred embodiment of the invention.

### DESCRIPTION OF ILLUSTRATIVE EMBODIMENTS

The present invention is illustrated in further details by the following non-limiting examples.

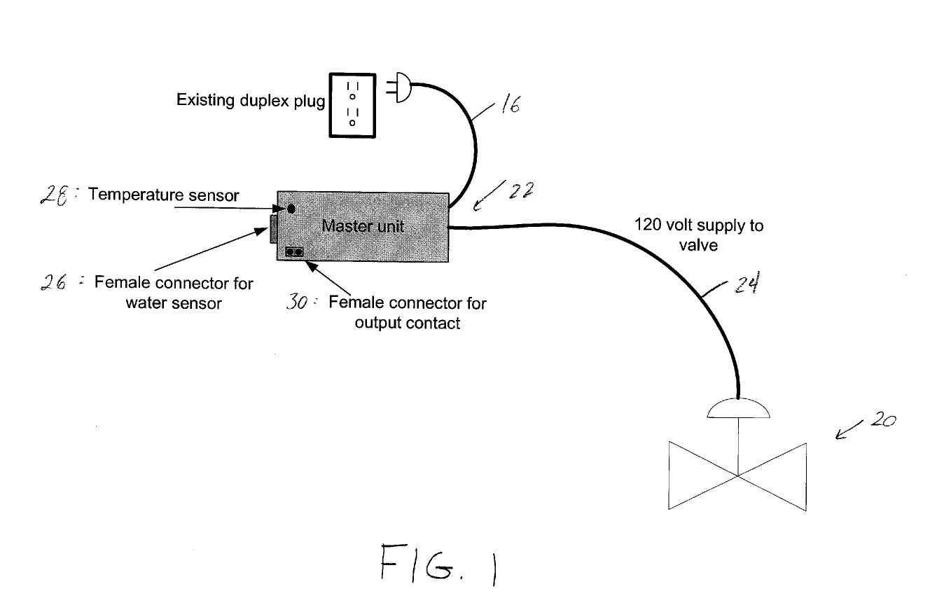

Referring now to FIG. 1, the water valve 20 and master unit 22 are described. The water valve 20 is preferably a 120-1-60 (or 50 cycles) water valve made by Burkett or Danfoss with a manual override. The master unit 22 is a main receptive unit with a 120-1-60 volt output to shut the water valve 20 via connection 24. The master unit 22 preferably has an input for a water sensor 26 and an on board temperature sensor 28, also with a contact output 30 to be linked to an existing alarm system. Preferably, the master unit includes is an electronic PCB of four layers with a Rhino198 PLC chip containing the following stand alone system features: Rx (receive) TX (transmit), water leak event detection from any slaves, activation of the 120-1-60 (or 50 cycles) water valve 20, activation of the dry contact to be connected to a existing alarm system, and low temperature event activation when this feature is activated. Events are preprogrammed within the Rhino™ PLC Chip (not shown). The Rhino™ PLC Chip can be reprogrammed using electrical line.

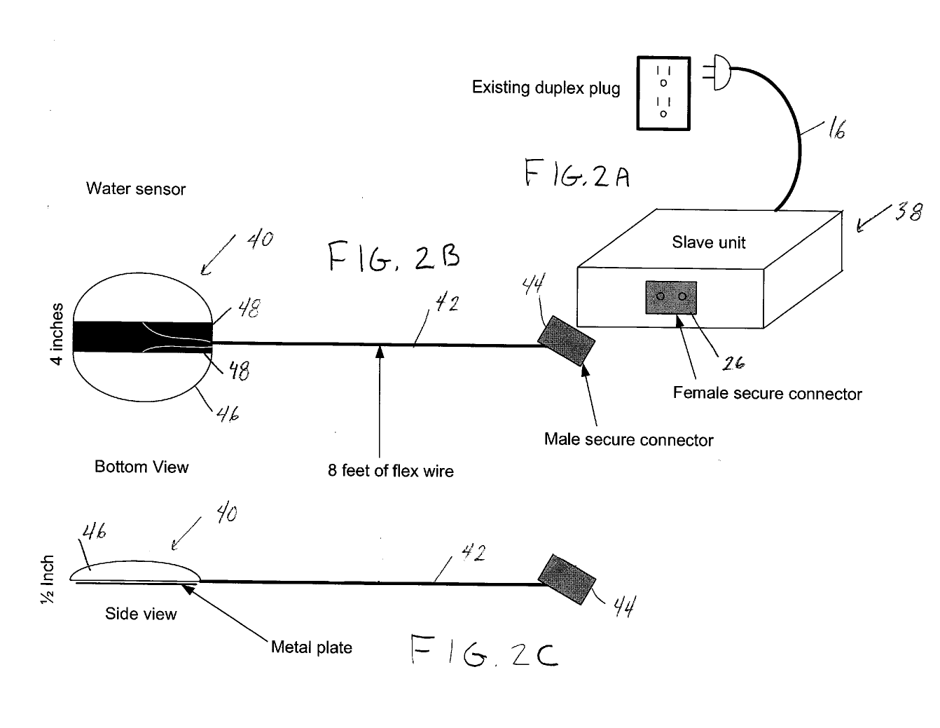

Referring now to FIGS. 2A to 2C, the water slave units 38 and water sensors 40 are described. The slave unit 38 is adapted to communicate with the master unit 22 and with any other slave units. It may be connected into any counter duplex plug located within the facility and comprises an input for a water sensor 26. The master 22 once installed may be factory matched in 2, 3 or 4 slave units plus a display status unit 32, which is described below. One master unit 22 may theoretically support more than 16 million slaves 38 based on the addressing scheme but the memory of the master unit 22 actually dictates how many slave units 38 are supported. The water sensor 40 preferably includes an height feet non corrosive flexible wire 42 with a secure quick connect 44 to be connected to the slave unit 38 or the master unit 22. The water sensor 40 sits directly on a floor surface and it can be slid under equipment such as a dishwasher, a clothing washer and others. The water sensor 40 may be composed of a plastic block 46 having two pieces of stainless steel both connected to a wire 48. When these two pieces of metal are shorted, a mill-volt signal is sent over the two wires to the slave unit 38 or master unit 22 to which the sensor 40 is connected. The slave unit or master unit transforms the millivolt signal into an event and sends the event thought the electrical wiring in the facility. The event is caught by the master unit 22 which shuts the water valve 20 off and sends a water detection event to the display unit 32. The display unit 32 lights up the related LED. The water sensors 40 are located as near as possible to water equipment (not shown) such as a water heater, a dishwasher, a clothing washer, a bathtub, a toilet, a water fountain, an air conditioner, a water heat pump, geothermal units or any component were pressurized water is present.

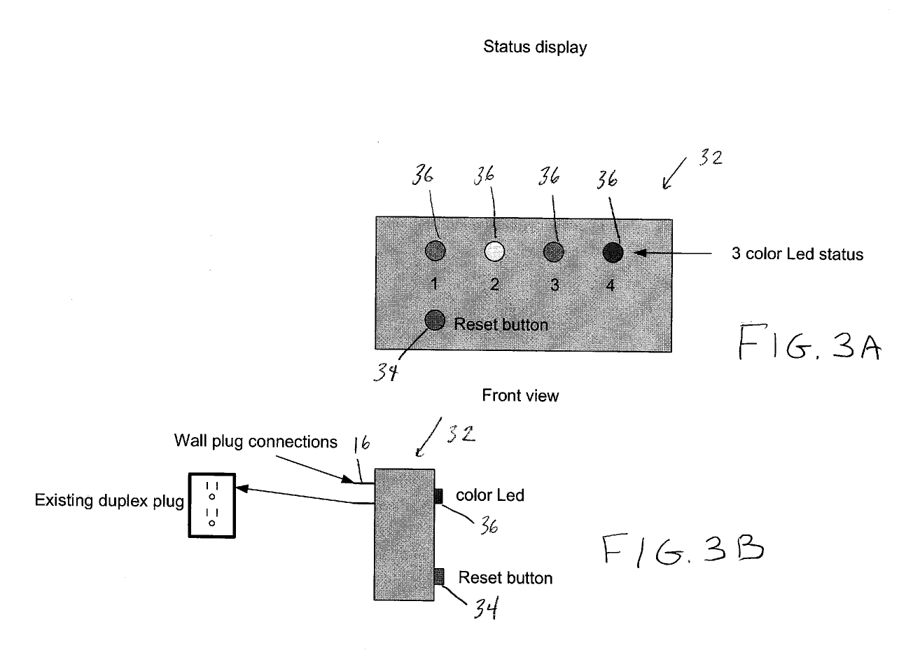

Referring now to FIGS. 3A and 3B, the display unit 32 is described. The display unit 32 may include a reset button 34 to reactivate the system after a water leak detection. The display unit may also include three or four LED pilot lights 36 with the following suggested color code: GREEN is when the system is in standby and working fine; YELLOW is when there is a communication problem; RED is when a water leak is detected. The display unit 32 may be connected into any counter duplex plug located within the facility.

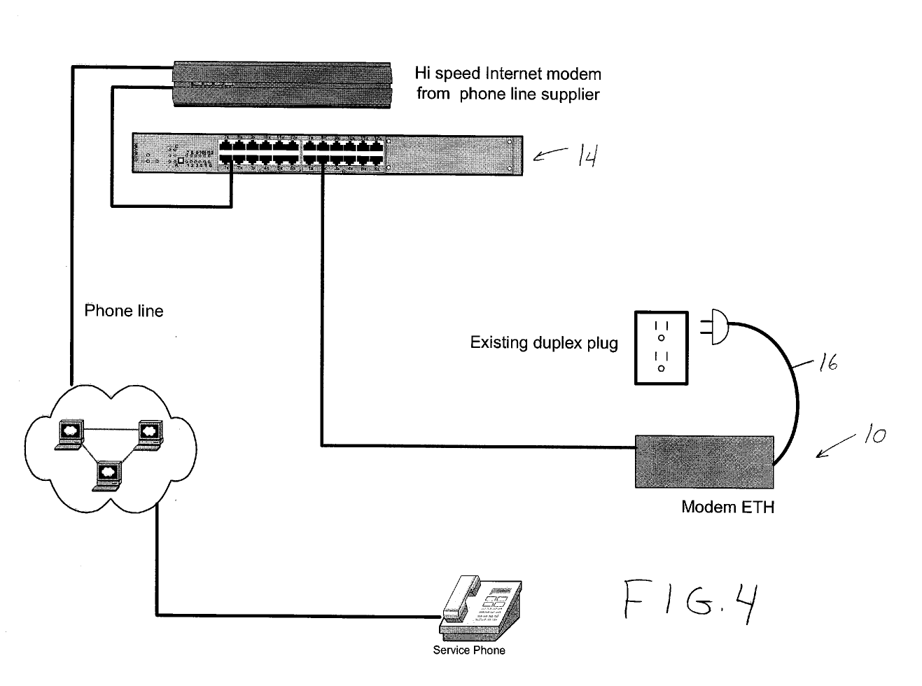

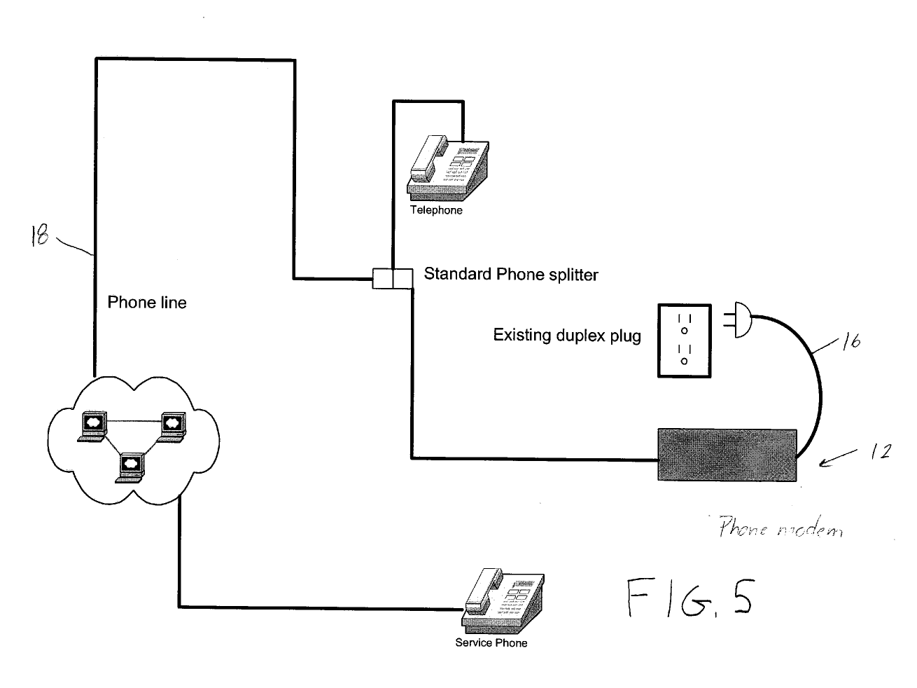

Referring to FIGS. 4 and 5, the connections and functioning of the of a water leak detection system's Ethernet modem 10 and of a water leak detection system's Phone modem 12 are described. The water leak detection system's Ethernet modem 10 preferably is an IP modem connected to an existing Ethernet router, the Ethernet router 14 being connected to Internet. This modem has a 120-1-60 (or 50 cycles) volt cord connection 16 that may be plugged to a duplex plug near the Ethernet router or into the same Power bar. Cellular, phone numbers, e-mail addresses and text messages can be programmed into the modems 10 or 12. The water leak detection system's Phone modem 12 preferably is a component connected directly to the incoming phone line 18 of the facility. This modem has a 120-1-60 (or 50 cycles) volt cord connection 16 which may be plugged to a duplex plug near the any phone using a phone Y type Jack to connect to the incoming phone line.

Although the present invention has been described hereinabove by way of specific embodiments thereof, it can be modified, without departing from the spirit and nature of the subject invention as defined in the appended claims.

1. A water leak detection system for generating a control signal indicative of a water leak detection, the system being connectable to a power line carrying an AC power signal, the system comprising:
a master unit connectable to the power line for generating the control signal indicative of a water leak detection;
one or more slave units connectable to the power line for communicating with the master unit;
one or more sensors for detecting a water leak, each sensor being connected to a slave unit; and
a communication system for transmitting and receiving data signals between the master unit and each slave unit in the AC power signal, the communication system including an encoder for encoding outbound data into the AC power signal using frequency shift keying (FSK) signals and a decoder for decoding inbound frequency shift keying (FSK) signals from the AC power signal.

2. The water leak detection system of claim 1, further comprising a water valve connected to the master unit, the water valve being shut off in response to receiving the control signal from the master unit.

3. The water leak detection system of claim 1, wherein the master unit further includes a temperature sensor for shutting off the valve when the ambient temperature reaches a predetermined limit.

4. The water leak detection system of claim 1, wherein the master unit is connected to one or more water sensors for detecting a water leak.

5. The water leak detection system of claim 1, wherein the master is connected to an existing alarm system.

6. The water leak detection system of claim 1, wherein the master is programmed to shut off the water valve if the power line is shut down.

7. The water leak detection system of claim 1, further comprising a status display unit connectable to the power line for communicating with the communication system, the display unit including light emitting diodes indicative of a status of the water leak detection system.

8. The water leak detection system of claim 7, wherein the status display unit further comprises a reset button for resetting the water leak detection system after a water leak detection.

9. The water leak detection system of claim 1, further comprising an ethernet modem connectable to the power line for communicating with the communication system, the modem being connected to a internet modem for transmitting alarm messages to the group including a cellular phone number, a land-line phone, an e- mail address and text message.

10. The water leak detection system of claim 1, further comprising a phone modem connectable to the power line for communicating with the communication system, the modem being connected to a phone line for transmitting alarm messages through the phone line.
